(19) United States
(12) Patent Application Publication
(10) Pub. No.: US 2025/0217932 A1
(43) Pub. Date: Jul. 3, 2025

(54) IMAGE ENHANCEMENT METHOD AND SYSTEM, AND STORAGE MEDIUM

(71) Applicant: WUHAN UNITED IMAGING HEALTHCARE CO., LTD., Wuhan (CN)

(72) Inventor: Lu Ma, Wuhan (CN)

(21) Appl. No.: 19/002,675

(22) Filed: Dec. 26, 2024

(30) Foreign Application Priority Data
Dec. 27, 2023 (CN) 202311825438.9

(51) Int. Cl. G06T 5/50; G06T 3/40; G06T 5/20; G06T 5/70; G06T 7/13

(52) U.S. Cl. CPC G06T 5/50; G06T 3/40; G06T 5/20; G06T 5/70; G06T 7/13; G06T 2207/10132; G06T 2207/20192; G06T 2207/30004

(57) ABSTRACT

An image enhancement method is disclosed. The method includes: decomposing a first image based on echo distribution of the first image to obtain a plurality of echo layers of the first image, with part of the plurality of echo layers having pixel values larger than or equal to a preset threshold being used as a first echo layer, and part of the plurality of echo layers having pixel values less than the preset threshold being used as other echo layers; decomposing the first echo layer based on depth information of each pixel in the first echo layer to obtain a plurality of depth maps of the first echo layer; obtaining a first enhanced image with an enhanced edge based on the plurality of depth maps and the first echo layer; and obtaining a first target image based on the first enhanced image and the other echo layers.

### CROSS-REFERENCE TO RELATED APPLICATIONS

The present application claims priority to Chinese Patent Application No. 2023118254389, filed on Dec. 27, 2023, the entire content of which is incorporated herein by reference.

### TECHNICAL FIELD

The present disclosure relates to the field of ultrasound image processing, and in particular, to an image enhancement method and system, and a storage medium.

### BACKGROUND

In an imaging process of a medical ultrasonic image, due to existence of speckle noise, not only the contrast of the image is reduced, the details of the image are blurred, but also local blocky artifacts are generated, which not only limits the clinical application of the medical ultrasonic image, but also causes difficulty in subsequent quantitative analysis such as image segmentation. Therefore, the processing of the ultrasonic medical image mainly includes speckle noise suppression and image enhancement to improve image quality, so that the processed ultrasonic medical image can assist in a medical diagnosis.

When the ultrasonic medical image is enhanced, in a traditional method, generally, after a low-contrast image with a poor visual effect acquired under a non-good illumination condition is obtained, gray scale transformation is performed on the low-contrast image, and a contrast of the low-contrast image is adjusted to enhance the contrast of the original image.

However, the ultrasonic medical image obtained by processing using the traditional image enhancement method still has problems of few effective details and poor uniformity, so that the quality of the ultrasonic medical image obtained by processing using the traditional method is low.

### SUMMARY

A first aspect of the present disclosure provides an image enhancement method. The method includes: decomposing a first image based on echo distribution of the first image to obtain a plurality of echo layers of the first image, with part of the plurality of echo layers having pixel values larger than or equal to a preset threshold being used as a first echo layer, and part of the plurality of echo layers having pixel values less than the preset threshold being used as other echo layers; decomposing the first echo layer based on depth information of each pixel in the first echo layer of the first image to obtain a plurality of depth maps of the first echo layer; obtaining a first enhanced image with an enhanced edge based on the plurality of depth maps and the first echo layer; and obtaining a first target image based on the first enhanced image and the other echo layers.

In some embodiments, obtaining the first enhanced image with the enhanced edge based on the plurality of depth maps and the first echo layer includes: extracting a first edge contour of each of the plurality of depth maps, and blending the first edge contours of the plurality of depth maps based on preset weights of the plurality of depth maps to generate a first blended edge contour; and obtaining the first enhanced image based on the first blended edge contour and the first echo layer.

In some embodiments, after extracting the first edge contour of each of the plurality of depth maps, the method further includes: determining a filtering strength for each pixel based on a gradient amplitude of each pixel of the first edge contour, and enhancing each pixel based on the filtering strength.

In some embodiments, after extracting the first edge contour of each of the plurality of depth maps, the method further includes: determining a filtering direction for each pixel based on a gradient direction of each pixel of the first edge contour, and enhancing each pixel based on the filtering direction.

In some embodiments, after extracting the first edge contour of each of the plurality of depth maps, the method further includes: determining a filtering strength for each pixel based on a gradient amplitude of each pixel of the first edge contour; determining a filtering direction for each pixel based on a gradient direction of each pixel of the first edge contour; and enhancing each pixel based on the filtering strength and the filtering direction.

In some embodiments, extracting the first edge contour of each of the plurality of depth maps includes: acquiring first edge pixels of a connected domain in each of the plurality of depth maps, and denoising the first edge pixels; acquiring second edge pixels with pixel values meeting a preset condition from the denoised first edge pixels; and obtaining the first edge contour based on the second edge pixels and the first echo layer.

In some embodiments, acquiring the first edge pixels of the connected domain in each of the plurality of depth maps includes: acquiring the connected domain in each of the plurality of depth maps, and taking pixels on an independent edge of each connected domain as the first edge pixels.

In some embodiments, acquiring the second edge pixels with the pixel values meeting the preset condition from the denoised first edge pixels includes: determining pixels with the pixel values less than a pixel threshold in the denoised first edge pixels as the second edge pixels.

In some embodiments, the method further includes: decomposing an original image based on a spatial frequency band to obtain a plurality of decomposed images with different scales; and denoising the decomposed image, and obtaining the first image based on the denoised decomposed image.

In some embodiments, the method further includes: performing multi-band blending on the first target image and a second target image to obtain an enhanced image of the original image, the second target image being obtained based on a second image, and the first image and the second image being decomposed images of different scales obtained by decomposing the original image based on a spatial frequency band.

In some embodiments, decomposing the first image based on the echo distribution of the first image to obtain the plurality of echo layers of the first image includes: acquiring a pixel value of each pixel in the first image, the pixel value being used for indicating the echo distribution of the first image; and dividing the pixels in the first image based on the pixel values, and obtaining the plurality of echo layers of the first image based on a pixel division result.

In some embodiments, decomposing the first echo layer based on the depth information of each pixel in the first echo layer of the first image to obtain the plurality of depth maps of the first echo layer includes: performing edge extraction on the first echo layer to obtain a plurality of second edge contours in the first echo layer; obtaining a depth value of a centroid of each of the plurality of second edge contours based on the depth information of each pixel in the first echo layer; and dividing the first echo layer based on the depth values to obtain the plurality of depth maps of the first echo layer.

In some embodiments, obtaining the first target image based on the first enhanced image and the other echo layers includes: enhancing contrasts of boundaries of the other echo layers to obtain a second enhanced image; and blending the first enhanced image and the second enhanced image to obtain the first target image.

A second aspect of the present disclosure provides an image enhancement system including a memory storing a computer program and a processor. When the computer program is executed by the processor, the processor is caused to: decompose a first image based on echo distribution of the first image to obtain a plurality of echo layers of the first image, with part of the plurality of echo layers having pixel values larger than or equal to a preset threshold being used as a first echo layer, and part of the plurality of echo layers having pixel values less than the preset threshold being used as other echo layers; decompose the first echo layer based on depth information of each pixel in the first echo layer to obtain a plurality of depth maps of the first echo layer; obtain a first enhanced image with an enhanced edge based on the plurality of depth maps and the first echo layer; and obtain a first target image based on the first enhanced image and the other echo layers.

A third aspect of the present disclosure provides a computer-readable storage medium having a computer program stored thereon. When the computer program is executed by a processor, the processor is caused to: decompose a first image based on echo distribution of the first image to obtain a plurality of echo layers of the first image, with part of the plurality of echo layers having pixel values larger than or equal to a preset threshold being used as a first echo layer, and part of the plurality of echo layers having pixel values less than the preset threshold being used as other echo layers; decompose the first echo layer based on depth information of each pixel in the first echo layer to obtain a plurality of depth maps of the first echo layer; obtain a first enhanced image with an enhanced edge based on the plurality of depth maps and the first echo layer; and obtain a first target image based on the first enhanced image and the other echo layers.

### BRIEF DESCRIPTION OF THE DRAWINGS

In order to describe the technical solutions in the embodiments of the present application or the conventional technology more clearly, the following will briefly introduce the accompanying drawings required for describing the embodiments or the conventional technology. Apparently, the accompanying drawings in the following description are merely embodiments of the present disclosure, and for a person of ordinary skill in the art, other drawings can be obtained based on the disclosed drawings without creative efforts.

FIG. 1 is a schematic flow diagram illustrating an image enhancement method according to an embodiment.

FIG. 2 is a schematic diagram illustrating an image enhancement algorithm based on multi-scale decomposition and image layering in an embodiment.

FIG. 3 is a schematic flow diagram illustrating an image enhancement method

according to another embodiment.

FIG. 4 is a structural block diagram illustrating an image enhancement device according to an embodiment.

FIG. 5 is a structural block diagram illustrating an ultrasonic imaging system according to an embodiment.

FIG. 6 is a schematic diagram illustrating an internal configuration of a computer device according to an embodiment.

### DETAILED DESCRIPTION

The technical solutions in the embodiments of the present disclosure will be clearly and completely described with reference to the accompanying drawings. Apparently, the described embodiments are only some but not all of the embodiments of the present disclosure. Based on the embodiments of the present disclosure, all other embodiments obtained by a person of ordinary skill in the art without creative efforts shall fall within the protection scope of the present disclosure.

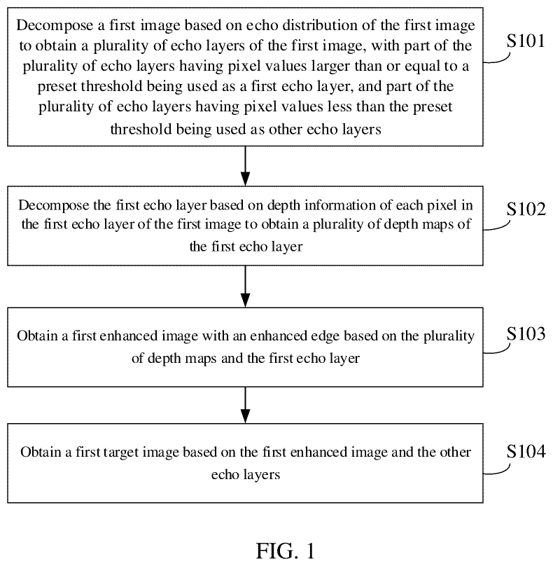

In an embodiment, as shown in FIG. 1, an image enhancement method is provided, and this embodiment is illustrated by applying the method to a terminal. It is to be understood that the method may alternatively be applied to a server or a system including a terminal and a server, and is implemented through interaction between the terminal and the server. In this embodiment, the method includes the following steps.

In step S101, a first image is decomposed based on echo distribution of the first image to obtain a plurality of echo layers of the first image. Part of the plurality of echo layers having pixel values larger than or equal to a preset threshold are used as a first echo layer, and part of the plurality of echo layers having pixel values less than the preset threshold are used as other echo layers.

The first image is an ultrasonic medical image which may be an unprocessed ultrasonic medical image or an ultrasonic medical image subjected to speckle noise suppression. The echo distribution of the first image is used for indicating a strength of an echo signal of a tested object. The echo layers correspond to different echo signal strength intervals respectively, and the number of the echo layers obtained by decomposing the first image can be set according to user requirements. For example, the first image can be decomposed by setting different preset ranges, so as to obtain the plurality of echo layers with the pixel values within the different preset ranges.

The first echo layer includes part of the plurality of echo layers of the first image in which image structures have low definition. In general, regions with weak echo signals are prone to have positions with unclear image structures, and edge contours are required to be extracted and enhanced. The regions with weak echo signals correspond to dark parts in the first image, so that pixels with the pixel values larger than or equal to the preset threshold in the plurality of echo layers are taken as the first echo layer. Pixels with the pixel values less than the preset threshold in the plurality of echo layers are taken as the other echo layers, and image structures of the other echo layers are relatively clear. The preset threshold may be specified by a user.

Exemplarily, taking decomposition of the first image based on the strength of the echo signal to obtain two echo layers as an example, a strong echo layer is obtained based on a region of the first image with a high echo signal strength, and a weak echo layer is obtained based on a region of the first image with a low echo signal strength. Similarly, the first image may be decomposed based on the strength of the echo signal to obtain more than two echo layers. Further, the pixels with the pixel values larger than or equal to the preset threshold in the plurality of echo layers are used as the first echo layer, and the pixels with the pixel values less than the preset threshold in the plurality of echo layers are used as the other echo layers.

In step S102, the first echo layer is decomposed based on depth information of each pixel in the first echo layer to obtain a plurality of depth maps of the first echo layer.

The depth information of each pixel in the first echo layer includes, but is not limited to, a detection depth of a tissue corresponding to each pixel in the first echo layer in reality during ultrasonic detection. When the ultrasonic medical image is acquired, energy of an ultrasonic wave is gradually attenuated with an increase of the depth in a propagation process. Therefore, ultrasonic attenuation conditions of regions of the first echo layer can be distinguished based on the depth information of the pixels, so as to obtain the depth map indicating the ultrasonic attenuation conditions.

In step S103, a first enhanced image with an enhanced edge is obtained based on the plurality of depth maps and the first echo layer.

Specifically, the edge contour may be extracted and enhanced based on the plurality of depth maps and the first echo layer, so as to obtain the first enhanced image with the enhanced edge. The edge contours can be extracted for all the depth maps, the extracted edge contours are blended, and then, the first enhanced image is obtained based on an edge contour obtained through the blending and the first echo layer. That is, the first enhanced image is an image obtained by performing edge enhancement on the first echo layer.

In step S104, a first target image is obtained based on the first enhanced image and the other echo layers.

Specifically, the first echo layers include the part of the plurality of echo layers of the first image in which the image structures have low definition, and the other echo layers of the first image include part of the plurality of echo layers with relative clear image structures and image edges. The first enhanced image is an image obtained by performing the edge enhancement on the first echo layer. The first target image is an image obtained by improving the definition of a part of the first image where the image structure has low definition.

In this embodiment, the first image is decomposed based on the echo distribution of the first image to obtain the plurality of echo layers of the first image, the part of the plurality of echo layers having the pixel values larger than or equal to the preset threshold are used as the first echo layers, and the part of the plurality of echo layers having the pixel values less than the preset threshold are used as the other echo layers, so that only the dark part of the image can be processed, and a structure of a bright part of the image is not influenced. When the first echo layer is processed, the first echo layer is decomposed based on the depth information of each pixel in the first echo layer to obtain the plurality of depth maps of the first echo layer. Since the tissues at different detection depths have different signal attenuation degrees in the imaging process, the edge contours in different depth maps have different definition degrees, and the tissues at different detection depths can be respectively subjected to edge enhancement by processing the plural depth maps and the first echo layer, so as to obtain the edge-enhanced first enhanced image. Based on the first enhanced image and the other echo layers, the first target image with an improved contour contrast is obtained, and the structures of the image bright parts in the first target image corresponding to the other echo layers are reserved, thereby improving quality of the ultrasonic medical image.

In some embodiments, obtaining the first enhanced image with the enhanced edge based on the plurality of depth maps and the first echo layer includes: extracting a first edge contour of each of the plurality of depth maps, and blending the first edge contours of the plurality of depth maps based on preset weights of the plurality of depth maps to generate a first blended edge contour; and obtaining the first enhanced image based on the first blended edge contour and the first echo layer.

Specifically, the first edge contour of each of the plurality of depth maps can be extracted, and the first edge contours of the plurality of depth maps are blended based on the preset weights of the plurality of depth maps to generate the first blended edge contour. Optionally, edge extraction is performed on each depth map to obtain pixels with large gradient amplitude changes in each of the plurality of depth maps, and the pixels with the large gradient amplitude changes are taken as the first edge contour of each of the plurality of depth maps. Different preset weights are set for different depth maps, and weighted summation is performed on the first edge contour based on the preset weights to realize the blending of the first edge contours. The first echo layer with the enhanced first edge contour, i.e., the first enhanced image, is obtained based on the first blended edge contour and the first echo layer.

Since the ultrasonic wave is attenuated to different degrees at different detection depths to affect a pixel strength of the ultrasonic medical image, different preset weights may be set for different depth maps based on actual experience values, so as to meet requirements of the detection depths concerned in different ultrasonic scanning imaging processes.

In the image enhancement method, the first image is decomposed to obtain the plurality of echo layers, and only the first edge contour of the first echo layer is processed, so that the structure of the bright part of the image is not influenced while the edge contrast of the dark part of the image is improved. When the first echo layer is processed, the first echo layer is decomposed to obtain the plurality of depth maps. Since the tissues at different detection depths have different signal attenuation degrees in the imaging process, the first edge contours of different depth maps have different definition degrees. For example, the first edge contour of a near field image is relatively clear, and the first edge contour of a far field image is relatively blurred. Different preset weights are set for different depth maps to blend the first edge contours, so that uniformity of the blended image contour can be ensured. Finally, the first target image is obtained based on the first enhanced image and the other echo layers of the first image, so that a contrast of the first edge contour is improved, and meanwhile, uniformity of the image is guaranteed, and more image details are reserved, thereby improving the quality of the ultrasonic medical image.

The first edge contours extracted from the same depth map may have different contour directions and different edge strengths. In order to improve the enhanced image quality, in some embodiments, after extracting the first edge contour of each of the plurality of depth maps, the method further includes: determining a filtering strength for each pixel based on a gradient amplitude of each pixel of the first edge contour, and enhancing each pixel based on the filtering strength.

The gradient amplitude of the pixel is positively correlated with the filtering strength. Optionally, the first edge contour with a large gradient amplitude is taken as a strong edge, and the first edge contour with a small gradient amplitude is taken as a weak edge. The filtering strength of the strong edge is large, and the filtering strength of the weak edge is small, so that different weights are set for the edges with different filtering strengths, and both the strong edge and the weak edge of the image have good transition effects.

In some embodiments, after extracting the first edge contour of each of the plurality of depth maps, the method further includes: determining a filtering direction for each pixel based on a gradient direction of each pixel of the first edge contour, and enhancing each pixel based on the filtering direction. The gradient direction corresponds to the pixel filtering direction. Optionally, coordinate axes are set for the depth map, the gradient amplitudes of each pixel in an X direction and a Y direction are calculated based on the coordinate axes, and the gradient direction of each pixel on the first edge contour is obtained based on the gradient amplitudes of the pixel in the X direction and the Y direction. A plurality of filters with different filtering directions are selected. Pixels in the image in specific gradient directions corresponding to the filtering directions are extracted through the filters in different directions, and the edge pixels in the specific gradient directions are filtered to enhance the image edge to ensure better continuity of the first edge contour.

In some embodiments, after extracting the first edge contour of each of the plurality of depth maps, the method further includes: determining a filtering strength for each pixel based on a gradient amplitude of each pixel of the first edge contour; determining a filtering direction for each pixel based on a gradient direction of each pixel of the first edge contour; and enhancing each pixel based on the filtering strength and the filtering direction. Optionally, the pixels on the first edge contour are filtered first based on the gradient amplitudes of the pixels, and the filtering strength is positively correlated with the gradient amplitudes of the pixels. Then, a binary image of each depth map is obtained based on the first edge contour obtained after the filtering. Point multiplication is performed on the binary image and an image of the first echo layer to obtain a boundary image of each depth map. The pixels on the first edge contour in the boundary image are filtered based on the gradient directions of the pixels, and the filtering directions correspond to the gradient directions of the pixels.

In order to accurately extract the first edge contour of each of the plurality of depth maps, the first edge contour of each of the plurality of depth maps may be denoised before the first edge contour is extracted. In some embodiments, extracting the first edge contour of each of the plurality of depth maps includes: acquiring first edge pixels of a connected domain in each of the plurality of depth maps, and denoising the first edge pixels; acquiring second edge pixels with pixel values meeting a preset condition from the denoised first edge pixels; and obtaining the first edge contour based on the second edge pixels and the first echo layer.

The connected domain in the image is obtained, and pixels on an independent edge of the connected domain are taken as the first edge pixels. Denoising the first edge pixels includes: filtering the first edge pixels to realize the denoising. Filtering methods include, but are not limited to, Gaussian filtering, mean filtering, median filtering, or the like. The preset condition is used for determining whether the pixel value of each pixel is less than a pixel threshold, so as to obtain all the pixels with the pixel values less than the pixel threshold and corresponding positions to form a mask.

Optionally, the first edge pixels are denoised by Gaussian filtering. A specified pixel value is obtained based on the preset condition. For example, the specified pixel value is obtained in the mask. Pixels with the pixel values larger than the specified pixel value are reserved in the first edge pixels, and pixels with the pixel values less than the specified pixel value are removed to obtain a new first edge contour. The new first edge contour is extracted to obtain a binary image. Point multiplication is performed on the binary image and the first echo layer to obtain a boundary image of a depth layer, and a first edge contour in the boundary image is extracted.

In this embodiment, some edge saw teeth of the image are eliminated through denoising, and then, the edge pixels are screened based on the pixel values, so that the edge saw teeth of the image are further reduced, the edge of the image becomes smooth and clear, and a saw tooth effect caused by the edge saw teeth is avoided, thereby improving the quality of the image obtained after image enhancement.

In some embodiments, the method further includes: decomposing an original image based on a spatial frequency band to obtain a plurality of decomposed images with different scales, the decomposed images having different spatial frequency bands; and denoising the decomposed image, and obtaining the first image based on the denoised decomposed image. The original image is an unprocessed ultrasonic medical image, and the original image may be acquired from an ultrasonic device or a database. The decomposed images with different scales correspond to different frequencies. The decomposed images are denoised, so that noise in different frequency ranges can be removed to improve a denoising effect on the image.

Optionally, speckle noise suppression is performed on the decomposed images with different scales based on an anisotropic diffusion method. Specifically, when anisotropic diffusion is performed on each pixel of the decomposed image, a local diffusion matrix is added to the image contour of the decomposed image, so that change speeds of the pixel values of the decomposed image in different directions can be adjusted based on gradient information of the pixels, so as to achieve the effect of inhibiting speckle noise, and meanwhile adjust the change speed of the pixel value at the contour of the decomposed image based on a local coherent diffusion matrix, thereby realizing texture enhancement of the decomposed image.

In some embodiments, the method further includes: performing multi-band blending on the first target image and a second target image to obtain an enhanced image of the original image, the second target image being obtained based on a second image, and the first image and the second image being decomposed images of different scales obtained by decomposing the original image based on a spatial frequency band. The original image is an unprocessed ultrasonic medical image.

The method for obtaining the second target image based on the second image is the same as the method for obtaining the first target image based on the first image. The second image may be one or more decomposed images with different scales from the first image. Optionally, Laplacian Pyramid decomposition is performed to obtain the first image and N second images with different scales from the first image, N being a positive integer. The first target image is obtained based on the first image, and N second target images are obtained based on the N second images. Laplacian Pyramid reconstruction is performed on the first target image and the N second target images to obtain an enhanced image of the original image.

In some embodiments, decomposing the first image based on the echo distribution of the first image to obtain the plurality of echo layers of the first image includes: acquiring a pixel value of each pixel in the first image, the pixel value being used for indicating the echo distribution of the first image; and dividing the pixels in the first image based on the pixel values, and obtaining the plurality of echo layers of the first image based on a pixel division result.

The pixel value of the region with a high echo signal strength is high, and the pixel value of the region with a low echo signal strength is low. Therefore, the echo distribution of the first image can be obtained based on the pixel values in the first image. Optionally, at least one preset value is obtained, and a plurality of non-overlapped preset ranges are obtained based on the preset value. The pixels with the pixel values in the same preset range in the first image are taken as one echo layer, and the plurality of echo layers are obtained based on the pixels in the plurality of preset ranges respectively.

In some embodiments, decomposing the first echo layer based on the depth information of each pixel in the first echo layer of the first image to obtain the plurality of depth maps of the first echo layer includes: performing edge extraction on the first echo layer to obtain a plurality of second edge contours in the first echo layer; obtaining a depth value of a centroid of each of the plurality of second edge contours based on the depth information of each pixel in the first echo layer; and dividing the first echo layer based on the depth values to obtain the plurality of depth maps of the first echo layer.

The pixels with large gradient amplitudes in the first echo layer are extracted to realize edge extraction of the first echo layer, and the pixels with large gradient amplitudes are used as the second edge contours of the first echo layer to obtain a plurality of second edge contours. The depth information of each pixel in the first echo layer includes a detection depth, a detection coordinate, and other information of the tissue corresponding to each pixel in the first echo layer in reality during detection. The centroid of each of the plurality of second edge contours may be determined based on each second edge contour. Further, the depth value of the centroid, i.e., a distance from an ultrasonic detection source to the tissue corresponding to the centroid in reality during detection, may be obtained based on the depth information of each pixel in the first echo layer and the centroid of the second edge contour. The larger the distance between the detected tissue and the detection source is, the larger the depth value is, and the signal attenuation degree is high when the pixels in the second edge contour corresponding to the centroid are generated, and vice versa.

Optionally, the depth values of the centroids of the second edge contours may be divided based on a specified ratio. At least one depth threshold may alternatively be obtained, and a plurality of non-overlapped depth ranges may be obtained from the depth threshold. The centroids are divided based on the depth ranges. A division result of the centroids is taken as a division result of the second edge contours corresponding to the centroids. The plurality of depth maps are obtained based on the division result of the second edge contours, so as to realize division of the first echo layer. Inner edges of the depth maps have different enhancement degrees.

In some embodiments, obtaining the first target image based on the first enhanced image and the other echo layers includes: enhancing contrasts of boundaries of the other echo layers to obtain a second enhanced image; and blending the first enhanced image and the second enhanced image to obtain the first target image.

The method for enhancing the contrasts of the boundaries of the other echo layers includes image sharpening, image edge filtering, or the like. Different echo layers in the ultrasonic medical image have different processing requirements respectively, the other echo layers of the first image include the part of the plurality of echo layers with the pixel values less than the preset threshold, the structure is relatively clear, and the contrasts of the boundaries of the other echo layers of the first image can be enhanced, so that the images of the other echo layers become clear and clean, the second enhanced image is obtained, and the number of the second enhanced images can be multiple.

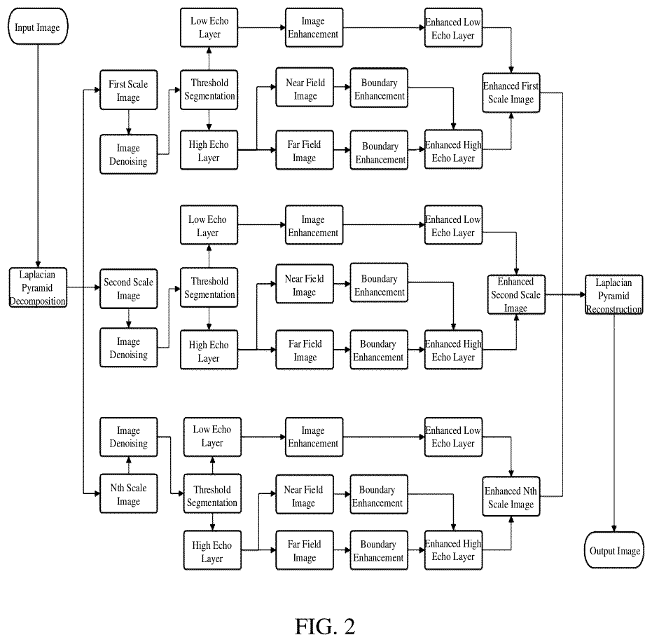

In some embodiments, FIG. 2 provides a schematic diagram illustrating an image enhancement method according to multi-scale decomposition and image layering. As shown in FIG. 2, first, an input image is divided into N scale images by using Laplacian Pyramid decomposition. The input image is an unprocessed ultrasonic medical image. Then, the N scale images are denoised respectively to avoid interference brought by noise in the image enhancement process. The image at each scale is divided into different echo layers based on a set threshold T, and as shown in FIG. 2, each of the images at different scales can be decomposed into a low echo layer and a high echo layer. Based on a detection distance of each tissue during ultrasonic detection, the high echo layer is decomposed into a plurality of depth maps, and as shown in FIG. 2, each high echo layer can be decomposed into a near field image and a far field image. Boundary enhancement is performed on each of the near field image and the far field image. Then, the near field images and the far field images corresponding to the same high echo layers are blended based on preset weights to obtain a plurality of enhanced high echo layers. Images of the low echo layers are enhanced to obtain a plurality of enhanced low echo layers. The enhanced high echo layers and the enhanced low echo layers corresponding to the same scale images are blended to obtain a plurality of enhanced scale images. Finally, an enhanced first scale image, an enhanced second scale image, . . . , and an enhanced Nth scale image are reconstructed by using the Laplacian Pyramid, and the images are output. The output image is the target image.

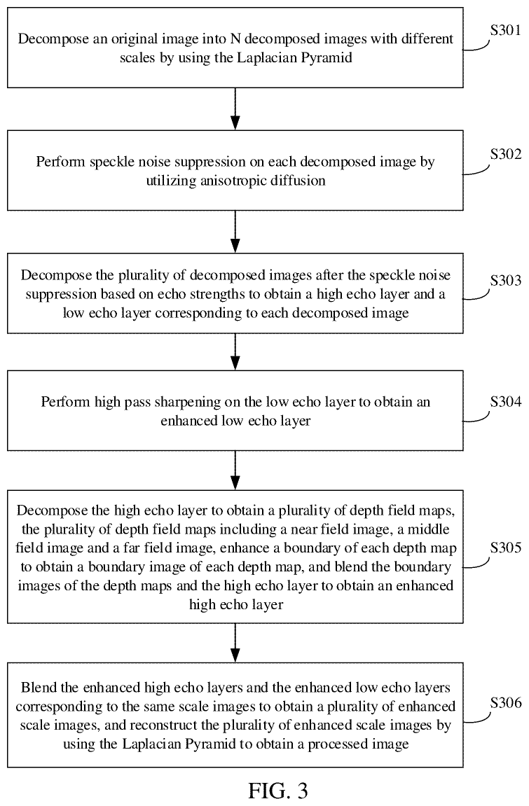

FIG. 3 provides a schematic flow diagram illustrating another image enhancement method, as shown in FIG. 2, including the following steps.

In step S301, an original image is decomposed into N decomposed images with different scales by using the Laplacian Pyramid.

The number of the scale images obtained by decomposition is set based on requirements. Theoretically, Laplacian Pyramid decomposition can be performed until only 1*1 is left at the end, and in this embodiment, N=4 is set in consideration of an efficiency and an actual scenario. Each time the original image is decomposed once, a width and height of the scale image obtained by decomposition are ½ of a width and height of the previous scale image.

In step S302, speckle noise suppression is performed on each decomposed image by utilizing anisotropic diffusion.

Since speckle noise is mainly concentrated on high-frequency components, the image is divided into the N layers in the image pyramid mode, and high-frequency and low-frequency information of the image is proposed. Nonlinear anisotropic diffusion is performed on the images with different frequency information, so as to adjust change speeds of pixel values based on gradient information of pixels to inhibit the speckle noise. Meanwhile, a local coherent diffusion matrix is added during the nonlinear anisotropic diffusion, and the nonlinear anisotropic diffusion is caused to act on a contour of the decomposed image through the local coherent diffusion matrix, so that texture enhancement of the decomposed image is realized while the speckle noise of the decomposed image is suppressed.

In step S303, the plurality of decomposed images after the speckle noise suppression are decomposed based on echo strengths to obtain a high echo layer and a low echo layer corresponding to each decomposed image.

The noise is removed in the decomposed image after the anisotropic diffusion, so that the image can better show different echo regions. The pixel values of the regions with different echo strengths are different, so that the high echo layer and the low echo layer can be obtained based on pixel value decomposition. After the speckle noise suppression of the decomposed image, the pixel value of the low echo layer may be a negative value, and in this case, the low echo layer can be suppressed to process the pixel with the negative value.

Optionally, the high echo layers are first echo layers, and the high echo layer includes a part in an image I after noise suppression with the pixel value greater than or equal to a preset threshold. The low echo layers are other echo layers, and the low echo layer includes a part of the image I after noise suppression with the pixel value less than the preset threshold. When the preset threshold is T, each pixel I(i,j) in the image I after noise suppression is decomposed by the threshold T using the following method.

In the process of obtaining a high echo layer P through segmentation, if the pixel value of the pixel I(i,j) is larger than or equal to the threshold T, the pixel I(i.j) is taken as a pixel P(i,j) in the high echo layer P. If the pixel value of the pixel I(i,j) is less than the threshold T, the value of the pixel with an abscissa i and an ordinate j in the high echo layer P is set as the threshold T, and then, the obtained value of each pixel in the high echo layer P is greater than or equal to the threshold T.

In the process of obtaining a low echo layer N through segmentation, if the pixel value of the pixel I(i,j) is less than the threshold T, the pixel I(i,j) is taken as a pixel N(i,j) in the low echo layer N. If the pixel value of the pixel I(i,j) is larger than the threshold T, the value of the pixel with an abscissa i and an ordinate j in the low echo layer N is set as the threshold T, and then, the obtained value of each pixel in the low echo layer N is less than or equal to the threshold T.

In this embodiment, in order to achieve both a processing efficiency and imaging quality, the high echo layer and the low echo layer are obtained by decomposition in this decomposition mode. It should be understood that more than two echo layers may alternatively be obtained from the decomposed image, and the decomposition of the echo layers may be implemented based on other existing decomposition methods.

In step S304, high pass sharpening is performed on the low echo layer to obtain an enhanced low echo layer.

In an ultrasonic medical image, the low echo layer is generally a lumen organ such as a blood vessel, and is often required to be processed to be cleaner, so that the low echo layer is subjected to the high pass sharpening once.

In step S305, the high echo layer is decomposed to obtain a plurality of depth maps. The plurality of depth maps includes a near field image, a middle field image and a far field image. A boundary of each depth map is enhanced to obtain a boundary image of each depth map, and the boundary images of the depth maps and the high echo layer are blended to obtain an enhanced high echo layer.

The high echo layer of the ultrasonic medical image presents contours in various directions, and in order to improve imaging quality of the ultrasonic medical image, image enhancement is required to be carried out on the basis of maintaining an original image structure. Considering an attenuation phenomenon existing in an ultrasonic scanning imaging process, a high echo region is divided into a near field, a middle field, and a far field based on positions of contour centroids in the image, the far field image has a weak signal, and the near field image has a strong signal. Different weights are set for different depth maps respectively, and a boundary of the far field image, a boundary of the middle field image, and a boundary of the near field image are blended based on the different weights, so that an image signal obtained after the blending has a uniform strength.

Optionally, a gradient amplitude of each pixel in a first edge contour of the depth map is obtained, and the pixels with different gradient amplitudes are filtered by filters with different filtering strengths. The gradient amplitudes of the pixels are in direct proportion to the filtering strengths, so that a better transition effect is achieved at an edge of the image. All the edges of each depth map are extracted to obtain a binary image thereof. Point multiplication is performed on the binary image and the high echo layer to obtain the boundary image of each depth map. The filters in different directions are correspondingly selected based on edge pixels with different gradient directions in the boundary image, and filtering is performed to obtain the boundary image with enhanced boundaries. The boundary image with enhanced boundaries and the high echo layer are blended based on preset weights to obtain an image in which an edge of the high echo layer is enhanced.

The more filters in different directions are selected, the better the edge continuity obtained after filtering is, and a calculation efficiency is relatively low correspondingly. In consideration of the balance between an efficiency and an effect, four Gabor filters in different directions are selected for boundary enhancement in this embodiment.

Optionally, when the binary image is obtained, in order to reduce a saw tooth effect, all independent first edge contours of each depth layer are found by using a connected domain, and then, the pixels on the first edge contours with gradient directions being a transverse direction and a longitudinal direction are filtered. The pixel values on the filtered first edge contour are determined, and the pixels with the pixel values larger than a specified pixel threshold are reserved to obtain a new first edge contour. A binary image with saw teeth eliminated is obtained based on the new first edge contour.

In step S306, the enhanced high echo layers and the enhanced low echo layers corresponding to the same scale images are blended to obtain a plurality of enhanced scale images, and the plurality of enhanced scale images are reconstructed by using the Laplacian Pyramid to obtain a processed image.

It should be understood that, although the steps in the flow charts involved in the above embodiments are shown in sequence as indicated by the arrows, the steps are not necessarily performed in sequence as indicated by the arrows. Unless explicitly stated herein, the steps are not limited to being performed in the exact order and may be performed in other orders. At least part of the steps in the flow charts involved in the above embodiments may include multiple steps or multiple stages, which are not necessarily performed at the same moment, but may be performed at different moments, and the steps or the stages are not necessarily performed in sequence, but may be performed alternately with other steps or at least part of the steps or the stages in other steps. For example, the step S304 and the step S305 may be performed in turn or alternately.

Based on the same inventive concept, the embodiment of the present disclosure further provides an image enhancement device for implementing the above image enhancement method. The implementation of the image enhancement device for solving problems in the traditional art is similar to the implementation of the method described in the above embodiments, and therefore, for the specific definitions in one or more embodiments of the image enhancement device provided below, reference can be made to the definitions of the image enhancement method in the above description, and the definitions are not repeated herein.

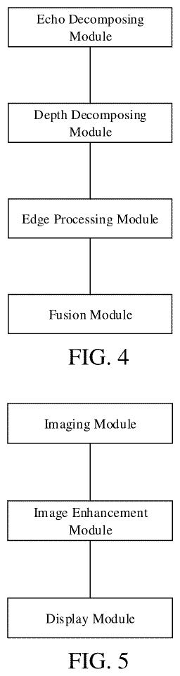

In an embodiment, as shown in FIG. 4, there is provided an image enhancement device, including an echo decomposing module, a depth decomposing module, an edge processing module, and a blending module. The echo decomposing module is configured to decompose a first image based on echo distribution of the first image to obtain a plurality of echo layers of the first image. Part of the plurality of echo layers having pixel values larger than or equal to a preset threshold are used as a first echo layer, and part of the plurality of echo layers having pixel values less than the preset threshold are used as other echo layers. The depth decomposing module is configured to decompose the first echo layer based on depth information of each pixel in the first echo layer of the first image to obtain a plurality of depth maps of the first echo layer. The edge processing module is configured to obtain a first enhanced image with an enhanced edge based on the plurality of depth maps and the first echo layer. The blending module is configured to obtain a first target image based on the first enhanced image and the other echo layers.

The modules in the image enhancement device may be wholly or partially implemented by software, hardware and a combination thereof. The modules may be embedded in or independent of a processor in an image enhancement system in hardware, or may be stored in a memory in the image enhancement system in software, so that the processor can conveniently call the modules to execute the operations corresponding to the modules.

Based on the same inventive concept, the embodiment of the present disclosure further provides an ultrasonic imaging system for implementing the above image enhancement method. The implementation of the ultrasonic imaging system for solving problems in the traditional art is similar to the implementation of the method described in the above embodiments, and therefore, for the specific definitions in one or more embodiments of the ultrasonic imaging system provided below, reference can be made to the definitions of the image enhancement method in the above description.

In an embodiment, as shown in FIG. 5, there is provided an ultrasonic imaging system, including: an imaging module, an image enhancement module, and a display module. The imaging module is configured to obtain a first image based on ultrasonic acquisition. The image enhancement module is configured to: decompose the first image based on echo distribution of the first image to obtain a plurality of echo layers of the first image. Part of the plurality of echo layers having pixel values larger than or equal to a preset threshold are used as a first echo layer, and part of the plurality of echo layers having pixel values less than the preset threshold are used as other echo layers. The image enhancement module is further configured to decompose the first echo layer based on depth information of each pixel in the first echo layer to obtain a plurality of depth maps of the first echo layer. The first echo layers include part of the plurality of echo layers having pixel values larger than or equal to a preset threshold. The image enhancement module is further configured to obtain a first enhanced image with an enhanced edge based on the plurality of depth maps and the first echo layer, and obtain a first target image based on the first enhanced image and the other echo layers. The display module is configured to display the first target image.

In an embodiment, the image enhancement module is further configured to: extract a first edge contour of each of the plurality of depth maps, and blend the first edge contours of the plurality of depth maps based on preset weights of the plurality of depth maps to generate a first blended edge contour; and obtain the first enhanced image based on the first blended edge contour and the first echo layer.

In an embodiment, after extracting the first edge contour of each of the plurality of depth maps, the image enhancement module is further configured to: determine a filtering strength for each pixel based on a gradient amplitude of each pixel of the first edge contour, and enhance each pixel based on the filtering strength.

In an embodiment, after extracting the first edge contour of each of the plurality of depth maps, the image enhancement module is further configured to: determine a filtering direction for each pixel based on a gradient direction of each pixel of the first edge contour, and enhance each pixel based on the filtering direction.

In an embodiment, after extracting the first edge contour of each of the plurality of depth maps, the image enhancement module is further configured to: determine a filtering strength for each pixel based on a gradient amplitude of each pixel of the first edge contour; determine a filtering direction for each pixel based on a gradient direction of each pixel of the first edge contour; and enhance each pixel based on the filtering strength and the filtering direction.

In an embodiment, the image enhancement module is further configured to: acquire first edge pixels of a connected domain in each of the plurality of depth maps, and denoise the first edge pixels; acquiring second edge pixels with pixel values meeting a preset condition from the denoised first edge pixels; and obtain the first edge contour based on the second edge pixels and the first echo layer.

In an embodiment, the image enhancement module is further configured to acquire the connected domain in each of the plurality of depth maps, and take pixels on an independent edge of each connected domain as the first edge pixels.

In an embodiment, the image enhancement module is further configured to determine pixels with the pixel values less than a pixel threshold in the denoised first edge pixels as the second edge pixels.

In an embodiment, the image enhancement module is further configured to: decompose an original image based on a spatial frequency band to obtain a plurality of decomposed images with different scales; and denoise the decomposed image, and obtain the first image based on the denoised decomposed image.

Optionally, the image enhancement module is further configured to perform multi-band blending on the first target image and a second target image to obtain an enhanced image of the original image. The second target image is obtained based on a second image, and the first image and the second image are decomposed images of different scales obtained by decomposing the original image based on a spatial frequency band.

In an embodiment, the image enhancement module is further configured to: acquire a pixel value of each pixel in the first image, the pixel value being used for indicating the echo distribution of the first image; and divide the pixels in the first image based on the pixel values, and obtain the plurality of echo layers of the first image based on a pixel division result.

In an embodiment, the image enhancement module is further configured to: perform edge extraction on the first echo layer to obtain a plurality of second edge contours in the first echo layer; obtain a depth value of a centroid of each of the plurality of second edge contours based on the depth information of each pixel in the first echo layer; and divide the first echo layer based on the depth values to obtain the plurality of depth maps of the first echo layer.

In an embodiment, the image enhancement module is further configured to: enhance contrasts of boundaries of the other echo layers to obtain a second enhanced image; and blend the first enhanced image and the second enhanced image to obtain the first target image.

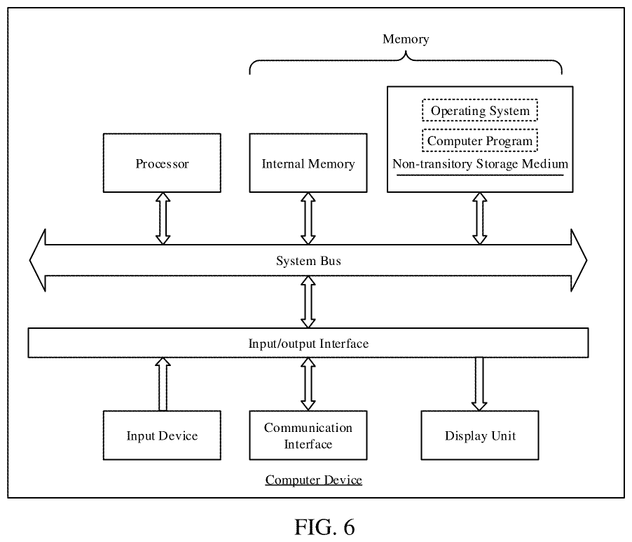

In an embodiment, there is provided an image enhancement system, which may include a computer device such as a terminal, an internal configuration of which may be shown in FIG. 6. The computer device includes a processor, a memory, an input/output interface, a communication interface, a display unit, and an input device. The processor, the memory, and the input/output interface are connected through a system bus, and the communication interface, the display unit, and the input device are connected to the system bus through the input/output interface. The input device is configured to input a first image to be processed, and the display unit is configured to display the first image and a target image after image enhancement. The processor of the computer device is configured to provide computing and control capabilities. The memory of the computer device includes a non-transitory storage medium and an internal memory. The non-transitory storage medium stores an operating system and a computer program. The internal memory provides an environment for running of the operating system and the computer program in the non-transitory storage medium. The input/output interface of the computer device is configured to exchange information between the processor and an external device. The communication interface of the computer device is configured to be communicated with an external terminal in a wired or wireless mode, and the wireless mode can be implemented through Wi-Fi, a mobile cellular network, near field communication (NFC), or other technologies. The computer program is executed by the processor to implement an image enhancement method. The display unit of the computer device is configured to form a visually visible picture and can be a display screen and a projection apparatus. The display screen may be a liquid crystal display screen or other types of display screens, and the input device of the computer device may be a touch layer covering the display screen, or may be a key, a trackball or a touch pad arranged on a casing of the computer device, or may be an external keyboard, touch pad, mouse, or the like.

Those skilled in the art will appreciate that the structure shown in FIG. 6 is only a block diagram illustrating a part of the configuration associated with the disclosed solution and does not constitute a limitation on the computer device to which the disclosed solution is applied, and a particular computer device may include more or fewer components than shown components, or combine certain components, or have a different arrangement of components.

In an embodiment, there is further provided an image enhancement system, including a memory storing a computer program and a processor. When the computer program is executed by the processor, the processor is caused to implement the steps of the method described in the above embodiments.

In an embodiment, there is provided a non-transitory computer-readable storage medium having a computer program stored thereon. When the computer program is executed by a processor, the processor is caused to implement the steps of the method described in the above embodiments.

It will be understood by those skilled in the art that all or part of the processes of the method according to the embodiments described above may be implemented by a computer program instructing related hardware, and the computer program may be stored in a non-transitory computer-readable storage medium, and when executed, may include the processes of the embodiments of the method described above. Any reference to memories, databases or other media used in the embodiments of the present disclosure can include at least one of a non-transitory memory and a volatile memory. The non-transitory memory may include a read-only memory (ROM), a magnetic tape, a floppy disk, a flash memory, an optical memory, a high-density embedded non-transitory memory, a resistive random access memory (ReRAM), a magnetoresistive random access memory (MRAM), a ferroelectric random access memory (FRAM), a phase change memory (PCM), a graphene memory, or the like. The volatile memory can include a random access memory (RAM), an external cache memory, or the like. By way of illustration and not limitation, the RAM can take many forms, such as a static random access memory (SRAM), a dynamic random access memory (DRAM), or the like. The databases involved in the embodiments of the present disclosure may include at least one of relational and non-relational databases. The non-relational database may include, but is not limited to, a block chain-based distributed database, or the like. The processors referred to in the embodiments of the present disclosure may include, but are not limited to, general processors, central processors, graphics processors, digital signal processors, programmable logic units, data processing logic units based on quantum calculations, or the like.

The technical features of the above-mentioned embodiments can be combined arbitrarily. In order to make the description concise, not all possible combinations of the technical features are described in the embodiments. However, as long as there is no contradiction in the combination of these technical features, the combinations should be considered to be included within the scope of this specification.

The above-described embodiments only illustrate several embodiments of the present disclosure, and the descriptions of which are relatively specific and detailed, but should not be construed as limiting the scope of the patent disclosure. It should be noted that, for those of ordinary skill in the art, several modifications and improvements can be made without departing from the concept of the present disclosure, and these all fall within the protection scope of the present disclosure. Therefore, the protection scope of the present disclosure should be determined by the appended claims.

What is claimed is:

1. An image enhancement method, comprising:
decomposing a first image based on echo distribution of the first image to obtain a plurality of echo layers of the first image, wherein part of the plurality of echo layers having pixel values larger than or equal to a preset threshold are used as a first echo layer, and part of the plurality of echo layers having pixel values less than the preset threshold are used as other echo layers;
decomposing the first echo layer based on depth information of each pixel in the first echo layer to obtain a plurality of depth maps of the first echo layer;
obtaining a first enhanced image with an enhanced edge based on the plurality of depth maps and the first echo layer; and
obtaining a first target image based on the first enhanced image and the other echo layers.

2. The method of claim 1, wherein obtaining the first enhanced image with the enhanced edge based on the plurality of depth maps and the first echo layer comprises:
extracting a first edge contour of each of the plurality of depth maps, and blending the first edge contours of the plurality of depth maps based on preset weights of the plurality of depth maps to generate a first blended edge contour; and
obtaining the first enhanced image based on the first blended edge contour and the first echo layer.

3. The method of claim 2, wherein after extracting the first edge contour of each of the plurality of depth maps, the method further comprises:
determining a filtering strength for each pixel based on a gradient amplitude of each pixel of the first edge contour; and
enhancing each pixel based on the filtering strength.

4. The method of claim 2, wherein after extracting the first edge contour of each of the plurality of depth maps, the method further comprises:
determining a filtering direction for each pixel based on a gradient direction of each pixel of the first edge contour; and
enhancing each pixel based on the filtering direction.

5. The method of claim 2, wherein after extracting the first edge contour of each of the plurality of depth maps, the method further comprises:
determining a filtering strength for each pixel based on a gradient amplitude of each pixel of the first edge contour;
determining a filtering direction for each pixel based on a gradient direction of each pixel of the first edge contour; and
enhancing each pixel based on the filtering strength and the filtering direction.

6. The method of claim 2, wherein extracting the first edge contour of each of the plurality of depth maps comprises:
acquiring first edge pixels of a connected domain in each of the plurality of depth maps, and denoising the first edge pixels;
acquiring second edge pixels with pixel values meeting a preset condition from the denoised first edge pixels; and
obtaining the first edge contour based on the second edge pixels and the first echo layer.

7. The method of claim 6, wherein acquiring the first edge pixels of the connected domain in each of the plurality of depth maps comprises:
acquiring the connected domain in each of the plurality of depth maps, and taking pixels on an independent edge of each connected domain as the first edge pixels.

8. The method of claim 5, wherein acquiring the second edge pixels with the pixel values meeting the preset condition from the denoised first edge pixels comprises:
determining pixels with the pixel values less than a pixel threshold in the denoised first edge pixels as the second edge pixels.

9. The method of claim 1, further comprising:
decomposing an original image based on a spatial frequency band to obtain a plurality of decomposed images with different scales; and
denoising the decomposed image, and obtaining the first image based on the denoised decomposed image.

10. The method of claim 1, further comprising:
performing multi-band blending on the first target image and a second target image to obtain an enhanced image of the original image, the second target image being obtained based on a second image, and the first image and the second image being decomposed images of different scales obtained by decomposing the original image based on a spatial frequency band.

11. The method of claim 1, wherein decomposing the first image based on the echo distribution of the first image to obtain the plurality of echo layers of the first image comprises:
acquiring a pixel value of each pixel in the first image, the pixel value being used for indicating the echo distribution of the first image; and
dividing the pixels in the first image based on the pixel values, and obtaining the plurality of echo layers of the first image based on a pixel division result.

12. The method of claim 1, wherein decomposing the first echo layer based on the depth information of each pixel in the first echo layer of the first image to obtain the plurality of depth maps of the first echo layer comprises:
performing edge extraction on the first echo layer to obtain a plurality of second edge contours in the first echo layer;
obtaining a depth value of a centroid of each of the plurality of second edge contours based on the depth information of each pixel in the first echo layer; and
dividing the first echo layer based on the depth values to obtain the plurality of depth maps of the first echo layer.

13. The method of claim 1, wherein obtaining the first target image based on the first enhanced image and the other echo layers comprises:
enhancing contrasts of boundaries of the other echo layers to obtain a second enhanced image; and
blending the first enhanced image and the second enhanced image to obtain the first target image.

14. An image enhancement system, comprising a memory storing a computer program, and a processor, wherein when the computer program is executed by the processor, the processor is caused to:
decompose a first image based on echo distribution of the first image to obtain a plurality of echo layers of the first image, wherein part of the plurality of echo layers having pixel values larger than or equal to a preset threshold are used as a first echo layer, and part of the plurality of echo layers having pixel values less than the preset threshold are used as other echo layers;
decompose the first echo layer based on depth information of each pixel in the first echo layer to obtain a plurality of depth maps of the first echo layer;
obtain a first enhanced image with an enhanced edge based on the plurality of depth maps and the first echo layer; and
obtain a first target image based on the first enhanced image and the other echo layers.

15. The image enhancement system of claim 14, wherein obtaining the first enhanced image with the enhanced edge based on the plurality of depth maps and the first echo layer comprises:
extracting a first edge contour of each of the plurality of depth maps, and blending the first edge contours of the plurality of depth maps based on preset weights of the plurality of depth maps to generate a first blended edge contour; and
obtaining the first enhanced image based on the first blended edge contour and the first echo layer.

16. The image enhancement system of claim 15, wherein when the computer program is executed by the processor, after extracting the first edge contour of each of the plurality of depth maps, the processor is further caused to:
determine a filtering strength for each pixel based on a gradient amplitude of each pixel of the first edge contour; and
enhance each pixel based on the filtering strength.

17. The image enhancement system of claim 15, wherein when the computer program is executed by the processor, after extracting the first edge contour of each of the plurality of depth maps, t the processor is further caused to:
determine a filtering direction for each pixel based on a gradient direction of each pixel of the first edge contour; and
enhance each pixel based on the filtering direction.

18. The image enhancement system of claim 15, wherein when the computer program is executed by the processor, after extracting the first edge contour of each of the plurality of depth maps, t the processor is further caused to:
determine a filtering strength for each pixel based on a gradient amplitude of each pixel of the first edge contour;
determine a filtering direction for each pixel based on a gradient direction of each pixel of the first edge contour; and
enhance each pixel based on the filtering strength and the filtering direction.

19. The image enhancement system of claim 15, wherein extracting the first edge contour of each of the plurality of depth maps comprises:
acquiring first edge pixels of a connected domain in each of the plurality of depth maps, and denoising the first edge pixels;
acquiring second edge pixels with pixel values meeting a preset condition from the denoised first edge pixels; and
obtaining the first edge contour based on the second edge pixels and the first echo layer.

20. A non-transitory computer-readable storage medium having a computer program stored thereon, when the computer program is executed by a processor, the processor is caused to:
decompose a first image based on echo distribution of the first image to obtain a plurality of echo layers of the first image, wherein part of the plurality of echo layers having pixel values larger than or equal to a preset threshold are used as a first echo layer, and part of the plurality of echo layers having pixel values less than the preset threshold are used as other echo layers;
decompose the first echo layer based on depth information of each pixel in the first echo layer to obtain a plurality of depth maps of the first echo layer;
obtain a first enhanced image with an enhanced edge based on the plurality of depth maps and the first echo layer; and
obtain a first target image based on the first enhanced image and the other echo layers.
